(19) United States
(12) Patent Application Publication
(10) Pub. No.: US 2026/0005476 A1
(43) Pub. Date: Jan. 1, 2026

(54) CONNECTOR ASSEMBLY WITH PRECISE TERMINAL ALIGNMENT FOR MATING INTERFACE

(71) Applicant: Aptiv Technologies AG, Schaffhausen (CH)

(72) Inventors: Manoharan SRINIVASAN, Chennai (IN); Gert DROESBEKE, Erkrath (DE)

(21) Appl. No.: 19/236,092

(22) Filed: Jun. 12, 2025

(30) Foreign Application Priority Data
Jun. 26, 2024 (IN) 202441049081

(51) Int. Cl. H01R 13/6585; H01R 43/02; H01R 43/20

(52) U.S. Cl. CPC H01R 13/6585; H01R 43/02; H01R 43/20

(57) ABSTRACT

The present disclosure presents a connector assembly including a female connector and a male counter-connector. The female connector has two female terminals, a female dielectric that guides and separates the terminals, and a female outer contact that encases both the dielectric and terminals. The male counter-connector features two male terminals, a male dielectric for guiding and separating the terminals, and a male outer contact that surrounds both the dielectric and terminals. The male counter-connector is designed to mate with the female connector such that each female terminal contacts a corresponding male terminal. The distance between the female terminals is less than or equal to 0.6 mm, thereby ensuring precise alignment and secure electrical connection upon mating. This configuration enhances the reliability and performance of the connector assembly in various applications.

### CROSS-REFERENCE TO RELATED APPLICATION

This application claims the benefit of and priority to Indian Provisional Application No. 202441049081 filed with the Indian Patent Office on Jun. 26, 2024, the contents of which are incorporated by reference herein.

### TECHNICAL FIELD

The present disclosure relates to a connector assembly for automotive applications especially multi-GHz applications which includes a male connector and a female connector.

### BACKGROUND

Traditional connector assemblies have been widely used in various electronic and electrical applications to facilitate the connection and disconnection of circuits. These assemblies typically consist of male and female components that engage to establish an electrical connection. Conventional designs often focus on ensuring reliable contact between terminals while maintaining case of use and durability. However, many existing connectors are designed with larger terminal spacing, which can limit their application in compact or miniaturized electronic devices where space is at a premium.

In previous approaches, connector assemblies have employed various dielectric materials to guide and separate the terminals within the connectors. These dielectrics are crucial for preventing short circuits and ensuring that the electrical connection is stable and secure. The outer contacts in these assemblies often serve as protective enclosures, shielding the internal components from environmental factors such as dust, moisture, and mechanical stress. Despite these protective measures, achieving a balance between miniaturization and maintaining robust electrical performance remains a challenge.

Efforts to reduce the size of connector assemblies have led to innovations in terminal design and material selection. Some designs have attempted to decrease the spacing between terminals to accommodate smaller form factors. However, these attempts often encounter issues related to maintaining electrical integrity and preventing arcing or short circuits, especially in high-density applications. The need for precise alignment and secure mating between connectors further complicates the design of compact connector assemblies.

However, none of these approaches have provided a comprehensive solution that combines the features described in this disclosure.

### SUMMARY

The disclosure presents an innovative solution to the problems discussed above.

In some aspects, the techniques described herein relate to a connector assembly, including a female connector containing two female terminals, a female dielectric and a female outer contact. The female dielectric guides and separates the female terminals. The female outer contact surrounds both the female dielectric and the female terminals. The connector assembly also includes a male counter-connector having two male terminals, a male dielectric and a male outer contact. The male dielectric guides and separates the male terminals. The male outer contact surrounds both the male dielectric and the male terminals. The male counter-connector is configured to mate with the female connector. Each female terminal contacts a respective male terminal when the female connector and the male counter-connector mates. A distance between the female terminals is less than or equal to 0.6 mm.

In some aspects, the techniques described herein relate to a method of manufacturing a female connector. The method includes:
providing a cable having two wires, striping a first wire of the two wires of the cable, providing two female terminals,
assembling a first female terminal with the first wire by pressing and welding them between two electrodes,
turning the assembly including the first female terminal and the first wire 90° clockwise,
striping a second wire of the two wires of the cable,
assembling the second female terminal with the second wire by pressing and welding them in between two electrodes, and
turning the assembly including the second female terminal and the second wire 90° counterclockwise, so that the two female terminals face each other and are located between the two wires.

In some aspects, the techniques described herein relate to a method of manufacturing a male connector, including:
providing two male terminals,
inserting a male dielectric over the two male terminals,
inserting an open male outer contact over the male dielectric,
closing the male outer contact by applying a rear portion of the male outer contact behind the male dielectric,
inserting a male over-housing over the male outer contact, and
placing a male hold-down on male over-housing and male outer contact.

### BRIEF DESCRIPTION OF THE DRAWINGS

Others features, details, and advantages of the disclosure will become more apparent from the detailed illustrating description given hereafter with respect to the drawings on which:

FIG. 1 shows an isometric view of a female connector according to some embodiments.

FIG. 2 shows another isometric view of the female connector of FIG. 1 according to some embodiments.

FIG. 3 shows a cross-sectional view along a longitudinal axis of the female connector of FIG. 1 according to some embodiments.

FIG. 4 shows an isometric view of a detail of the end of a female outer contact according to some embodiments.

FIG. 5 shows an exploded view of a male connector according to some embodiments.

FIG. 6 shows an isometric view of the male connector of FIG. 5 according to some embodiments.

FIG. 7 shows a side cross-sectional view along a longitudinal axis of the male connector of FIG. 5 according to some embodiments.

FIG. 8 shows, a top cross-sectional view along a longitudinal axis of the male connector of FIG. 5 according to some embodiments.

FIGS. 9 to 12 show isometric views of initial successive steps of manufacturing the female connector of FIG. 1 according to some embodiments.

FIG. 13 shows a top view of the step of FIG. 12 according to some embodiments.

FIG. 14 shows a side view of a first step of the welding process according to some embodiments.

FIG. 15 shows a front view of the first step of the welding process according to some embodiments.

FIG. 16 shows a front view of the second step of the welding process according to some embodiments.

FIGS. 17 to 20 show sides view of final steps of manufacturing the female connector according to some embodiments.

FIGS. 21 to 24 show isometric views of the steps of manufacturing the male connector according to some embodiments.

FIG. 25 shows a top cross-sectional view of the assembled connector according to some embodiments.

FIG. 26 shows a front view of the assembled connector according to some embodiments.

### DETAILED DESCRIPTION

This disclosure presents a connector assembly 1. The connector assembly 1 includes a female connector 2 and a male counter-connector 3 able to mate each other.

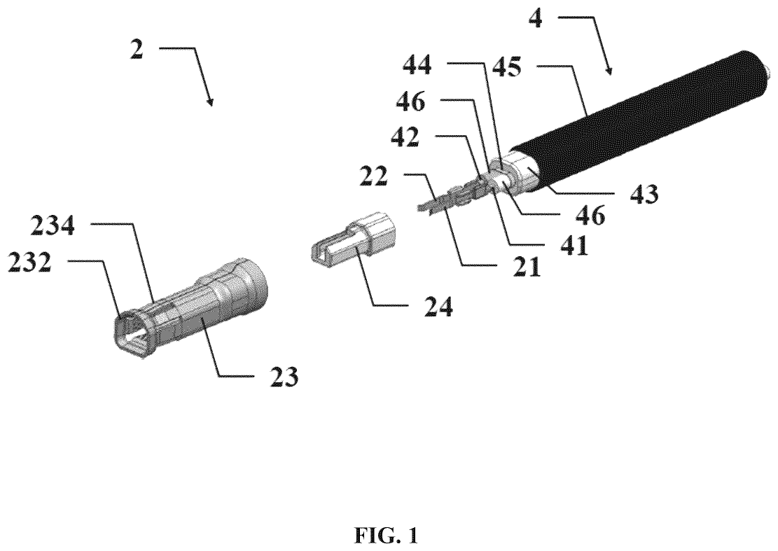

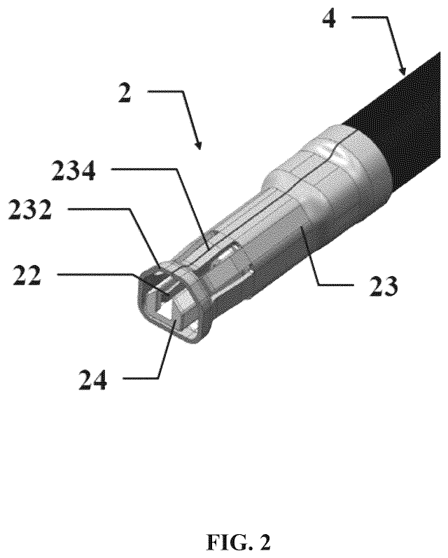

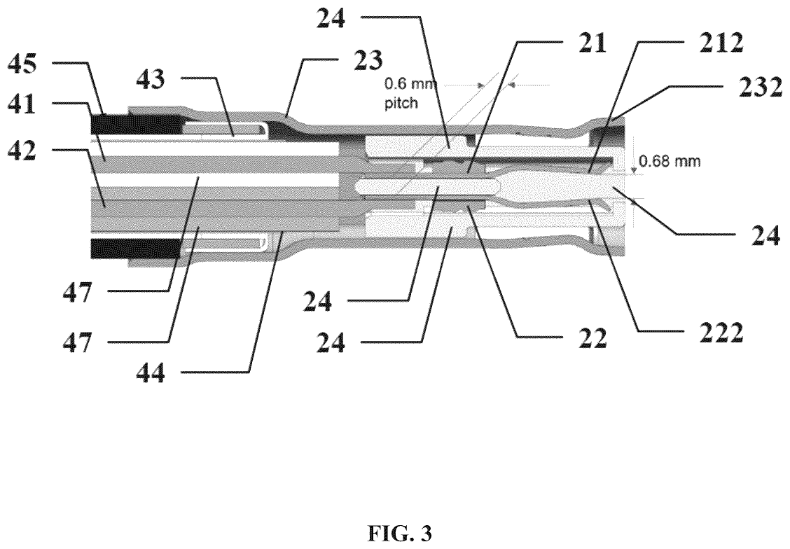

As illustrated in FIGS. 1 to 4, the female connector 2 includes two female terminals 21, 22, a female dielectric 24 and a female outer contact 23. The female dielectric 24 guides and separates the female terminals 21, 22 and the female outer contact 23 surrounds both the female dielectric 24 and the female terminals 21, 22. The female terminals 21, 22 are conductive and respectively carry the electrical signals. The female dielectric 24 is isolating. Its function is to support and guide the female terminals 21, 22 and to separate them so they cannot directly touch each other. The female outer contact 23 assembles and surrounds the other components of the female connector 2.

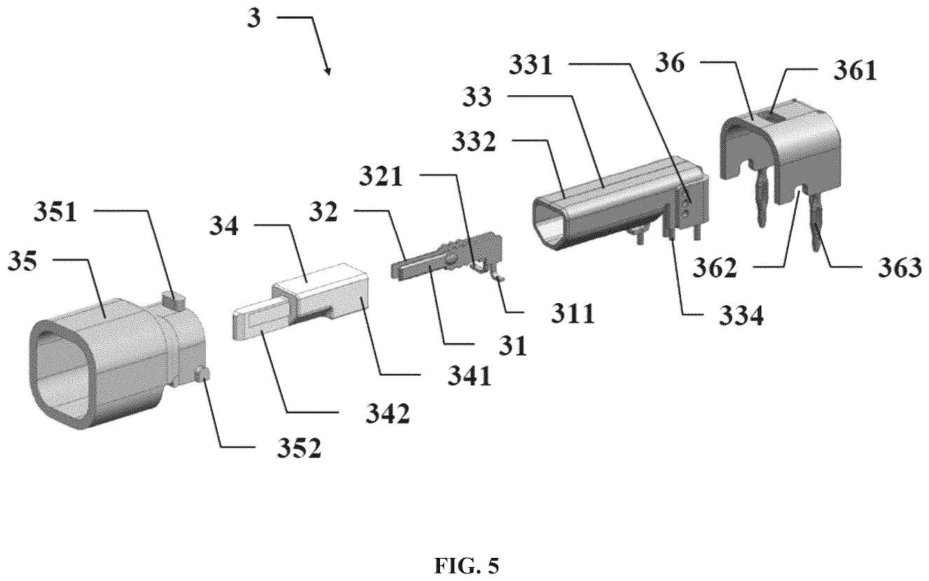

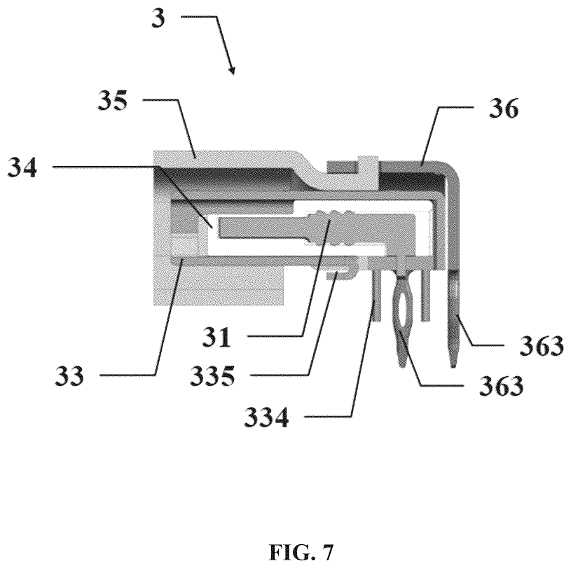

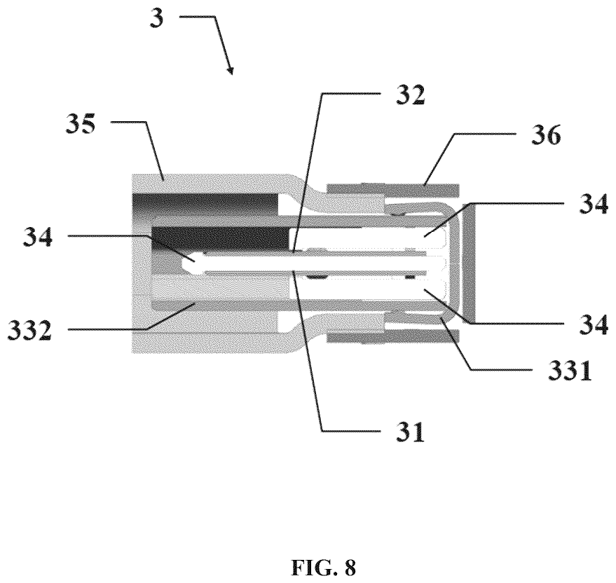

As illustrated in FIGS. 5 to 8, the male counter-connector 3 includes two male terminals 31, 32, a male dielectric 34 and a male outer contact 33. The male dielectric 34 guides and separates the male terminals 31, 32. The male outer contact 33 surrounds both the male dielectric 34 and the male terminals 31, 32. The male terminals 31, 32 are conductive and respectively carry the electrical signals. The male dielectric 34 is isolating. Its function is to support and guide the male terminals 31, 32 and to separate them so they cannot directly touch each other. The male outer contact 33 assembles and surrounds the other components of the male counter-connector 3.

The male counter-connector 3 and the female connector 2 are configured to mate one with the other. When the female connector 2 and the male counter-connector 3 mates, each female terminal 21, 22 contacts a corresponding male terminal 31, 32.

According to an important feature, the distance between the female terminals 21, 22 is lesser than or equal to 0.6 mm.

To obtain a pitch of 0.6 mm, both female connector 2 and male counter-connector 3 must be drastically miniaturized.

According to another feature, the female outer contact 23 shows a female transverse profile 232 nonsymmetrical with respect to a plane passing through the female terminals 21, 22. Complementarily, the male outer contact 33 shows a male transverse profile 332 complementary to the female transverse profile 232. Accordingly, the profiles 232, 332 allows the female connector 2 and the male counter-connector 3 to mate. Complementary profiles 232, 332, since they can mate in one orientation and not in the other orientation, allows a non-deceptive mating. Profiles 232, 332 jointly function as a keying means. The complementary profiles 232, 332 can be of any nonsymmetrical shape. As figured in the embodiment illustrated, the complementary profiles can be square with two corners truncated on the same side with respect to the plane.

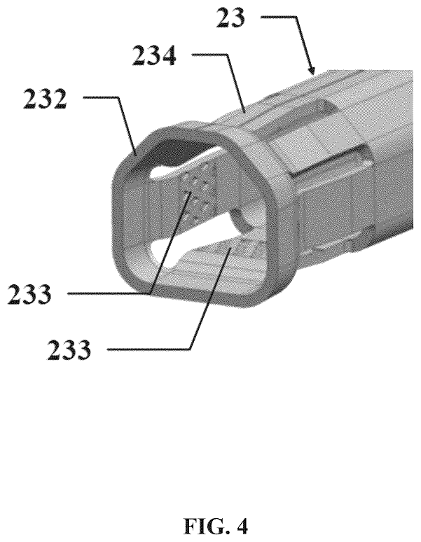

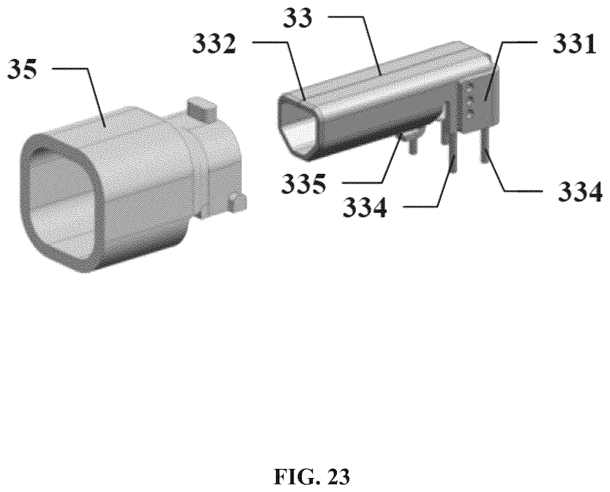

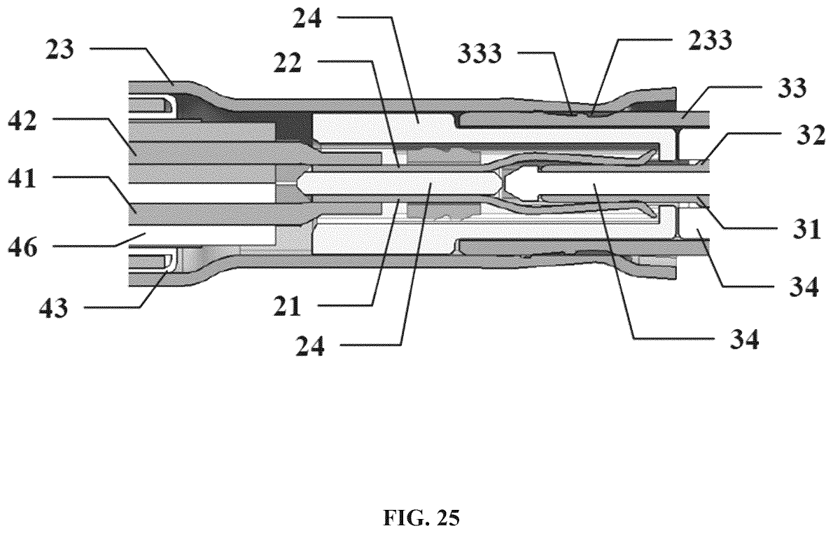

Moreover, as shows in detail of FIG. 4, in FIG. 23 and in FIG. 25, female outer contact 23 and male outer contact 33 are designed to mate with a strong contact between them. This is obtained through their respective complementary shapes. This may also be completed using blades 234, conferring elasticity to the female outer contact 23, allowing it to press around the male outer contact 33, especially its distal end. The strong contact is reinforced by knurled parts 233, 333 located on any or both of respective surface in regard of the outer contact 23, 33.

According to another feature, the female outer contact 23 is conductive and connected to the ground. This allows the female outer contact 23 to function as a shield. Similarly, the male outer contact 33 is conductive and connected to the ground. This allows the male outer contact 33 to function as a shield. To help with doing so, the outer contacts 23 and 33 are made of metallic materials. Alternately, they can be made of plastic inserted or coated with a conductive material. This feature is particularly interesting in the context of high frequency signals carried.

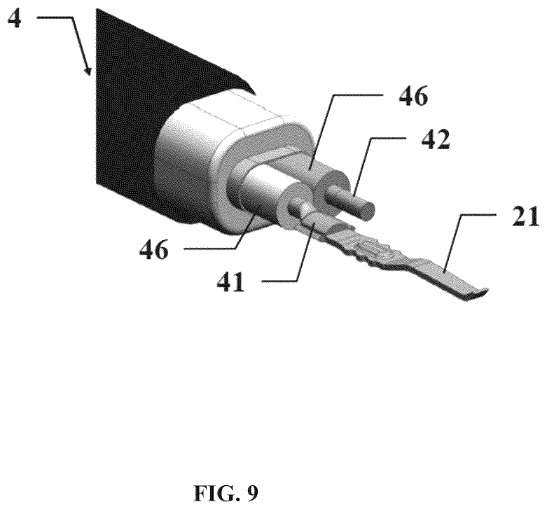

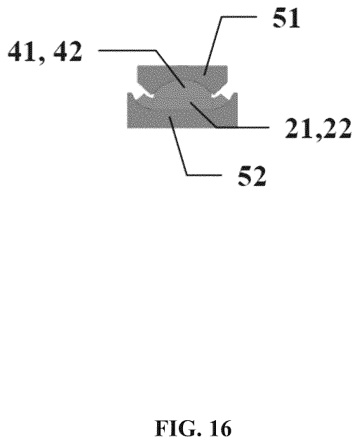

Another object of the invention is a method of manufacturing such a female connector 2. FIGS. 9 to 20 illustrate the method. In the described embodiment, the female connector 2 is intended to be connected to a cable 4.

Alternatively, the female connector 2 could be mounted on a circuit board with minor changes.

The method of manufacturing the female connector 2 includes the following steps.

A first step provides the cable 4. The cable 4 includes two wires 41 and 42. The cable 4 is preferentially a STP/SPP cable. Such a cable presents à pitch, that is a distance between its two wires 41, 42 generally equal to 0.6 mm. The cable 4 includes an individual insulator 46 around each wire 41, 42. Around the isolators 46, it includes a dielectric 44, isolating from a ground braid 43. Around the dielectric lies the ground braid 43. Around the ground braid 43, and thus all the components, is a sheath 45. The sheath 45 is isolating and mechanically protective.

During the second step, the first wire 41, and possibly the second wire 42, is stripped. To do so, the cable 4 is stripped, at its end, by removing the sheath 45 over a given length necessary to assemble with the female connector 2. The ground braid 43 is opened, over the same length, but kept and reserved. The dielectric 44 is stripped, generally over the same length. Finaly, the first wire 41, or both wires 41, 42, are freed from their individual insulator 46, generally over the same length.

During a third step, two female terminals 21, 22, are provided.

During a fourth step, the first female terminal 21 is assembled with the first wire 41. This is done by pressing and welding the first female terminal 21 and the first wire 41 in between two electrodes 51, 52. The resulting assembly is shown in FIG. 9.

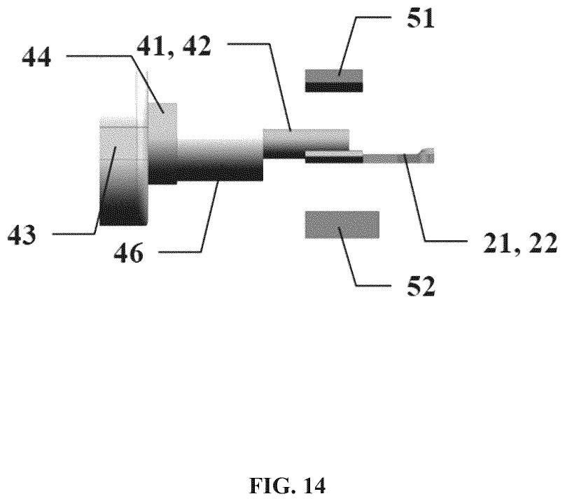

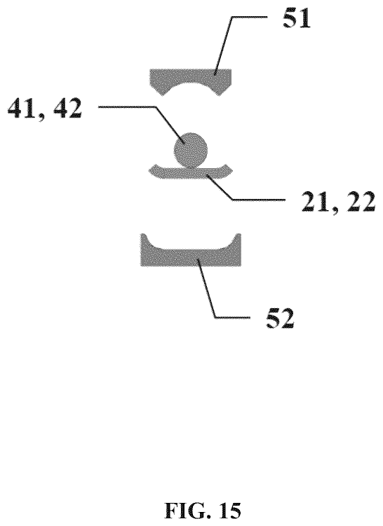

The step is more detailed in FIG. 14-16. As illustrated, in FIGS. 14-15, the first female terminal 21 is approached toward the first wire 41, now stripped. The first female terminal 21 includes a generally flat part on its proximal end 211. The flat proximal end 211 is placed in contact with the first wire 41, generally centered, to create a set. With reference to a plane passing through the two wires 41, 42, the first female terminal 21 is placed parallelly. Two electrodes 51 and 52 are placed on each respective sides of the set, with respect to the plane, one on each side.

The two electrodes 51, 52 are firmly pressed, one against another, encircling the set including the first female terminal 21 and the first wire 41. A high intensity current is established between the two electrodes 51, 52. The high intensity current creates a temperature raising in between the two electrodes 51, 52. The high temperature causes an at least partial melting of the first wire 41 and of the first female terminal 21, at least at its proximal end 211 in regard. The melting: first, causes a welding of the first wire 41 with the first female terminal 21 and second, allows a forging, mainly of the first wire 41. The electrodes 51 and 52 are shaped to forge, the set. In the end, the assembly section shows the shape of a flat pancake.

So doing, in one single process operation, two results are obtained: the first wire 41 and the first female terminal 21 are durably assembled, and moreover, the thickness of the set is drastically reduced.

It has been seen that the press and weld operation is done with a motion of electrodes 51, 52 generally perpendicular to the plane passing through the two wires 41 and 42. This is due to the necessary space needed for electrodes 51, 52 to operate. However, the thickness reduction is useful is the transverse direction, which is the direction passing through the two wires 41, 42.

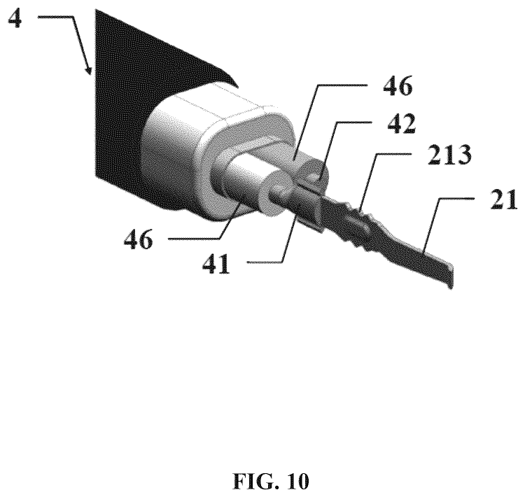

Accordingly, during a fifth step, the assembly including the first female terminal 21 and the first wire 41 is turned 90° clockwise. Clockwise is here defined when looking to the female connector 2 from its proximal end, which is from the cable end or the end opposed to the mating, the first wire 41 being on the right side. The rotation is applied to the assembly, together with the individual insulator 46 of the first wire 41. The rotation is applied so as the first female terminal 21 ends in between the two wires 41, 42. The resulting assembly of the turning step is particularly shown in FIG. 10.

After this, the same process is applied to the second wire 42 and the second female terminal 22.

During a sixth step, if it has not already been stripped, the second wire 42 is stripped, by removing its individual insulator 46.

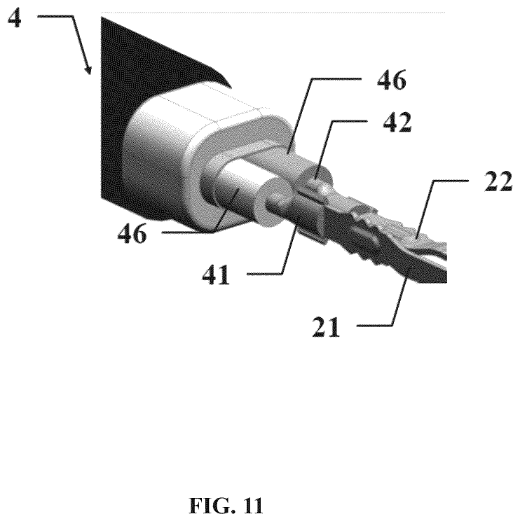

During a seventh step, the second female terminal 22 is assembled with the second wire 42. This is done by pressing and welding them in between two electrodes 51 and 52. The resulting assembly is shown in FIG. 11.

The step is more detailed in FIG. 14-16. As illustrated, in FIGS. 14 and 15, the second female terminal 22 is approached toward the second wire 42, now stripped. The second female terminal 22 includes a generally flat part on its proximal end 221. The flat proximal end 221 is placed in contact with the second wire 42, generally centered, to create a set. With reference to a plane passing through the two wires 41, 42, the second female terminal 22 is placed parallelly. Two electrodes 51 and 52 are placed on each respective sides of the set, with respect to the plane, one on each side.

The two electrodes 51, 52 are firmly pressed, one against another, encircling the set including the second female terminal 22 and the second wire 42. A high intensity current is established between the two electrodes 51, 52. The high intensity current creates a temperature raising in between the two electrodes 51, 52. The high temperature causes an at least partial melting of the second wire 42 and of the second female terminal 22, at least at its end 221 in regard. The melting: first, causes a welding of the second wire 42 with the second female terminal 22 and second, allows a forging, mainly of the second wire 42. The electrodes 51 and 52 are shaped to forge, the set. In the end, the assembly section shows the shape of a flat pancake.

So doing, in one single process operation, two results are obtained: the second wire 42 and the second female terminal 22 are durably assembled, and moreover, the thickness of the set is drastically reduced.

It has been seen that the press and weld operation is done with a motion of electrodes 51, 52 generally perpendicular to the plane passing through the two wires 41 and 42. This is due to the necessary space needed for electrodes 51, 52 to operate. However, the thickness reduction is useful is the transverse direction, which is along the plane passing through the two wires 41, 42.

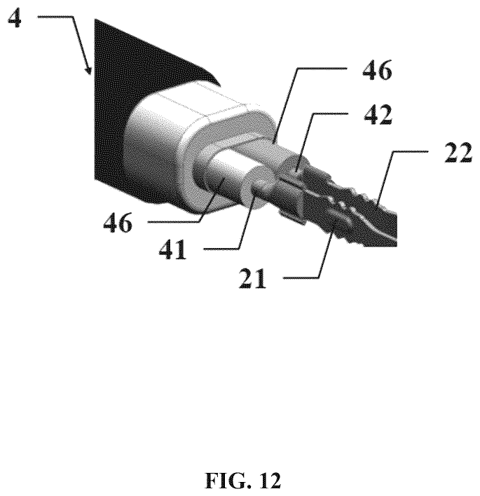

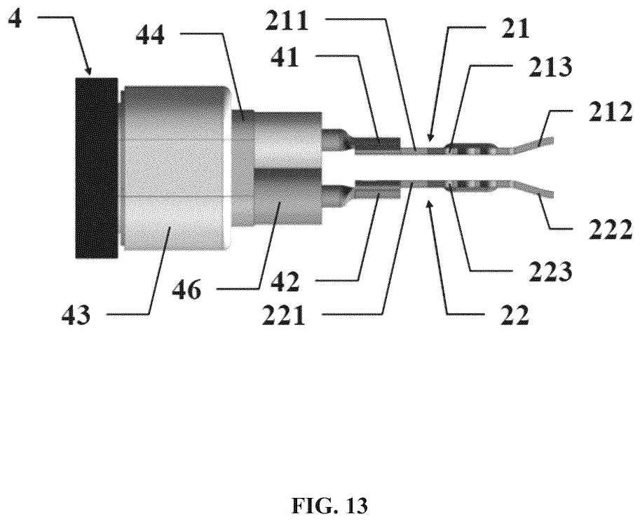

Accordingly, during an eighth step, the assembly including the second female terminal 22 and the second wire 42 is turned 90° counterclockwise. Counterclockwise is here defined when looking to the female connector 2 from its proximal end, which is from the cable end, or the end opposed to the mating. The rotation is applied to the assembly, together with the individual insulator 46 of the second wire 42. The rotation is applied so as the second female terminal 22 ends in between the two wires 41, 42. The resulting assembly of the turning step is particularly shown in FIGS. 12 and 13.

As particularly showed from the top, in FIG. 13, the two female terminals 21, 22 are facing each other and are located in between the two wires 41, 42.

According to another feature, the manufacturing of the female connector 2 carries on with the following steps.

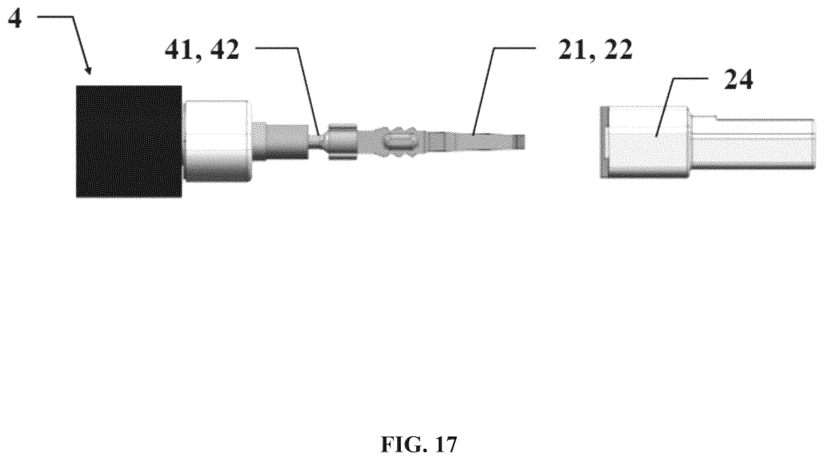

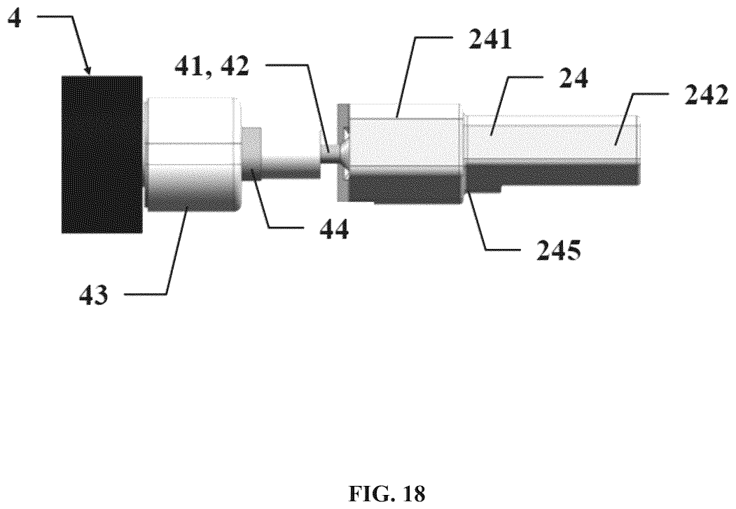

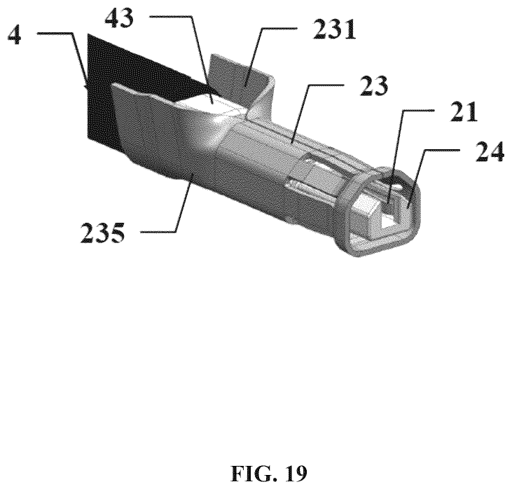

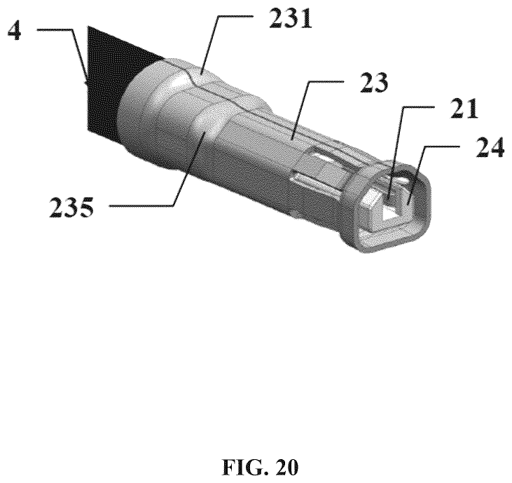

During a ninth step, a female dielectric 24 is inserted over the two female terminals 21, 22. This is particularly illustrated in FIGS. 17 and 18. FIG. 17 illustrates the preparation, when FIG. 18 illustrates the result of the insertion. The insertion is applied by translating, generally along the female connector's axis. The female dielectric 24 advantageously includes two recesses, each being able to welcome one of the two female terminals 21, 22. In the recesses, a toothed part is configured to welcome corresponding teeth 213, 223 respectively pertaining to the two female terminals 21, 22. This necessitates a force insertion of the female terminals 21, 22 and ensures a secure gripping of the female dielectric 24 around the female terminals 21, 22. The recesses, in collaboration with teeth 213, 223, also act as an abutment to stop the insertion and determine the longitudinal position, along the female conductor's axis, of the female terminals 21, 22 with respect to the female dielectric 24. During a tenth step an open female outer contact 23 is inserted over the female dielectric 24. This is particularly illustrated in FIGS. 18 to 20. FIG. 18 illustrates the preparation; FIG. 19 illustrates the result of the insertion, and FIG. 20 illustrates the resulting assembly. The insertion is applied by translating, generally along the female connector's axis. The female outer contact 23 is initially open. The female outer contact 23, at its proximal end, includes two cars 231. The cars 231 are initially open, to open the female outer contact 23.

At the base of the cars 231, the female outer contact 23 includes a section's reduction forming a first abutment 235. The female dielectric 24 includes a complementary section's reduction forming a second abutment 245 complementary to the first abutment 235. Both abutments 235, 245 cooperate to determine the longitudinal position of the female outer contact 23 with respect to the female dielectric 24, and to maintain it, at least in one sense. During an eleventh step, the ground braid 43 of the cable 4, which has been previously reserved during stripping step, is put in contact with the interior of the female outer contact 23, in order to get an electrical contact.

During a twelfth step, the female outer contact 23 is closed. This is done by crimping the cars 231 around the cable 4 and the ground braid 43. The step assembles the female outer contact 23 with cable 4. The assembly also maintain the female dielectric 24. The step finishes the female connector 2. The resulting assembly is shown in FIG. 20.

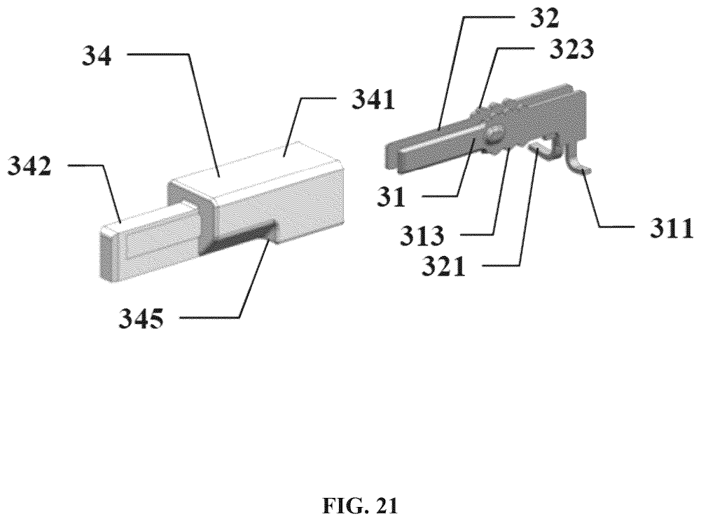

Another object of the invention is a method of manufacturing such a male counter-connector 3. The method is illustrated in FIGS. 21 to 24. In the described embodiment, the male counter-connector 3 is intended to be mounted and connected on a circuit board.

Alternatively, the male counter-connector 3, with some minor amendments, could be connected with a cable.

The method of manufacturing the male counter-connector 3 including the following steps.

During a first step, two male terminals 31, 32 are provided. A male terminal 31, 32 includes at least one pin 311, 312 to allow its assembling and connecting with a circuit board.

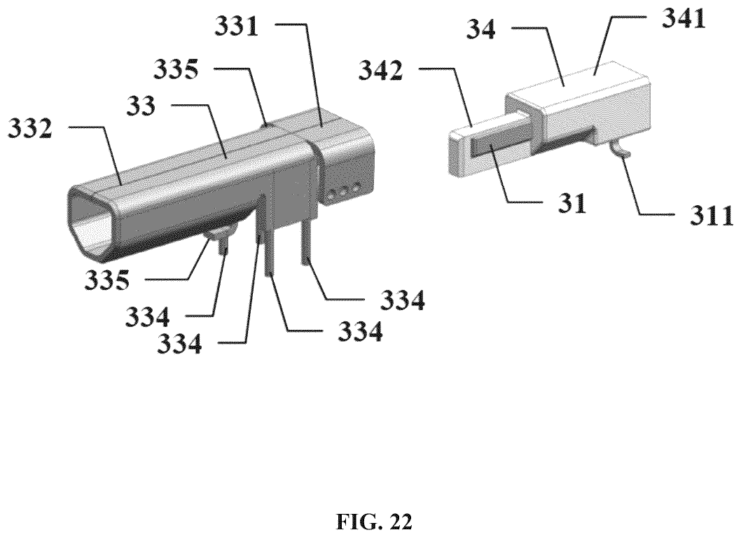

During a second step, a male dielectric 34 is inserted over the two male terminals 31, 32. This is particularly illustrated in FIGS. 21 and 22. FIG. 21 illustrates the preparation, while FIG. 22 illustrates the result of the insertion. The insertion is applied by translating, generally along the female connector's axis. The male dielectric 34 advantageously includes two recesses, each being able to welcome one of the two male terminals 31, 32. In the recesses, a toothed part is configured to welcome corresponding teeth 313, 323 respectively pertaining to the two male terminals 31, 32. This necessitates a force insertion of the male terminals 31, 32 and ensures a secure gripping of the male dielectric 34 around the male terminals 31, 32. The recesses, in collaboration with teeth 313, 323, also act as an abutment to stop the insertion and determine the longitudinal position, along the male conductor's axis, of the male terminals 31, 32 with respect to the male dielectric 34.

During a third step an open male outer contact 33 is inserted over the male dielectric 34. This is particularly illustrated in FIGS. 22 and 23. FIG. 22 illustrates the preparation, while FIG. 23 illustrates the resulting assembly. The insertion is applied by translating, generally along the male connector's axis. The male outer contact 33 is initially open. The male outer contact 23, at its proximal end, includes a rear 331, initially open, that is, aligned with the rest of the male outer contact 33. At the base of the rear 331, the male outer contact 33 includes a section's reduction forming a first abutment 335. The male dielectric 34 includes a complementary section's reduction forming a second abutment 345 complementary to the first abutment 335. Both abutments 335, 345 cooperate to determine the longitudinal position of the male outer contact 33 with respect to the male dielectric 34, and to maintain it, at least in one sense.

During a fourth step, the male outer contact 33 is closed. This is done by plying the rear 331 of the male outer contact 33, generally at 90°, behind the male dielectric 34. The step assembles the male outer contact 33 and the male dielectric 34. The resulting assembly is shown in FIG. 23, on the right. The male outer contact 33 includes four pins 334, generally disposed on a square shape, and a central pin, of matter with the male outer contact 33. The pins 334 are intended to attach the male outer contact 33, and thus the whole male counter-connector 3, to the circuit board, and to electrically connect it to the ground of the circuit board.

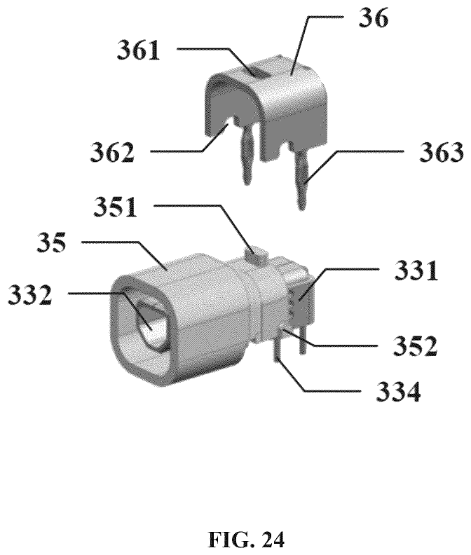

During a fifth step, a male over-housing 35 is inserted over the male outer contact 33. This is particularly illustrated in FIGS. 23 and 24. FIG. 23 illustrates the preparation, while FIG. 24 illustrates the resulting assembly. The insertion is applied by translating, generally along the male connector's axis. The male over-housing 35 proximal end abuts longitudinally when encountering the rear 331 and/or the pins 334 of the male outer contact 33.

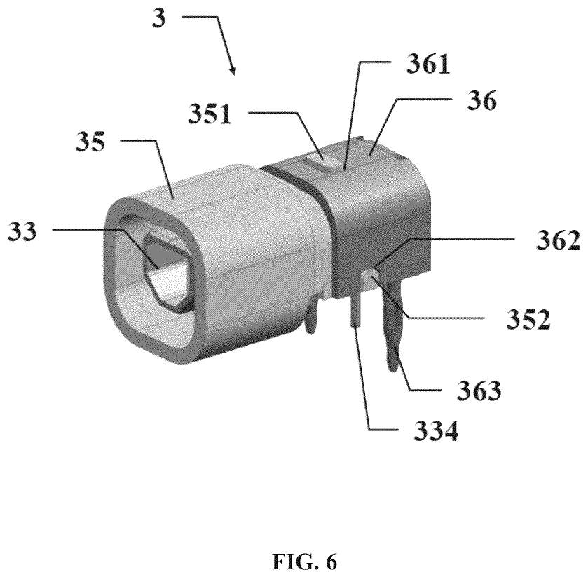

During a sixth step a male hold-down 36 is placed upon the male over-housing 35 and the male outer contact 33. This is particularly illustrated in FIGS. 24 and 6. FIG. 24 illustrates the preparation, while FIG. 6 illustrates the resulting assembly. The placing is applied by translating the male hold-down 36 along a direction generally perpendicular to the male connector's axis, from top to bottom.

While the male outer contact 33 is preferably electrically conductive to provide shielding properties, the male over-housing 35 and the male hold-down 36 aren't necessarily electrically conductive. The male over-housing 35 and the male hold-down 36 can both be made of plastic or metal. In the embodiment illustrated, the over-housing 35 is made of plastic and the hold-down 36 is made of metal.

The male outer contact 35 includes some tabs 351, 352, or recesses appaired with corresponding recesses 361, 362 or tabs on the male hold-down 36. The tabs or recesses are preferably able to clip one another. For example, as illustrated, the male hold-down 36 includes a central top recess 361 able to cooperatively welcome a central top tab 351 on the proximal end of the male outer contact 35. The male hold-down 36 further includes two lateral bottom recesses 362 able to cooperatively welcome respective lateral bottom tabs 352 on the proximal end of the male outer contact 35.

The male hold-down 36 further includes at least one pin 363, three: two lateral and one rear, in the illustrated embodiment. The pins 363 are the press-fit type. They are not intended to convey a signal and are not soldered on the circuit board. They are only intended to mechanically attach the male hold-down 36 to the circuit board, by pressing the press-fit pins 363 into corresponding holes pierced in the circuit board.

The placing of the male hold-down 36 maintains the male outer contact 35 in place and finishes the male counter-connector 3.

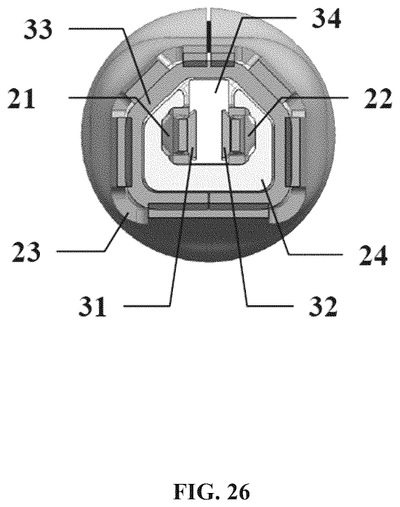

FIGS. 25 and 26 shows the mating of the female connector 2 and the male counter-connector 3, respectively from the top and from the front. The respective female terminals 21, 22 are in tight contact with the respective male terminals 31, 32. It can also be seen that the contact is along an extended length. The length of contact for each mating pair of terminals 21, 31, 22, 32 is at least 1.75 mm.

While there is shown and described the present preferred embodiment of the invention, it is to be distinctly understood that this invention is not limited thereto but may be variously embodied to practice within the scope of the following claims.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

### Reference Number List

1 connector assembly
2 female connector
21 first female terminal
211 proximal end
212 distal end
213 teeth
22 second female terminal
221 proximal end
222 distal end
223 teeth
23 female outer contact
231 ears
232 profile
233 knurled part
234 blade
235 abutment
24 female dielectric
241 proximal end
242 distal end
245 abutment
3 male connector
31 first male terminal
311 pin
313 teeth
32 second male terminal
321 pin
323 teeth
33 male outer contact
331 proximal end
332 profile
333 knurled part
334 pin
335 abutment
34 male dielectric
341 proximal end
342 distal end
35 male over-housing
351 central tab
352 lateral tab
36 male hold-down
361 central recess
362 lateral recess
363 press-fit pin
4 cable
41 first wire
42 second wire
43 ground braid
44 dielectric
45 sheath
46 insulator
51 upper electrode,
52 lower electrode

1. A connector assembly, comprising:
a female connector comprising two female terminals, a female dielectric and a female outer contact, the female dielectric configured to guide and separate the female terminals, and the female outer contact being configured to surround both the female dielectric and the female terminals; and
a male counter-connector comprising two male terminals, a male dielectric and a male outer contact, the male dielectric configured to guide and separate the male terminals and the male outer contact being configured to surround both the male dielectric and the male terminals, the male counter-connector being configured to mate with the female connector, each female terminal coming into contact with a respective male terminal when the female connector and the male counter-connector mates, and a distance between the female terminals being less than or equal to 0.6 mm.

2. The connector assembly according to claim 1, wherein the female outer contact has a female transverse profile that is non-symmetrical with respect to a plane passing through the female terminals and the male outer contact has a male transverse profile that is complementary to the female transverse profile, to mate with contact.

3. The connector assembly according to claim 1, wherein the female outer contact is electrically conductive and configured to be connected to ground to function as a shield and wherein the male outer contact is electrically conductive and configured to be connected to ground to function as a shield.

4. A method of manufacturing a female connector, the method comprising:
providing a cable comprising two wires,
striping a first wire of the two wires of the cable of an isolating and mechanically protective sheath;
providing two female terminals;
assembling a first female terminal with the first wire by pressing and welding them between two electrodes;
turning the assembly comprising the first female terminal and the first wire clockwise by 90°;
striping a second wire of the two wires of the cable of an isolating and mechanically protective sheath;
assembling the second female terminal with the second wire by pressing and welding them in between two electrodes; and
turning the assembly comprising the second female terminal and the second wire counterclockwise by 90°, so that the two female terminals face each other and are located between the two wires.

5. The method according to claim 4, further comprising:
inserting a female dielectric over the two female terminals;
inserting an open female outer contact over the female dielectric;
putting a ground braid of the cable in contact with the female outer contact; and
crimping the female outer contact to close it around the cable.

6. A method of manufacturing a male connector, comprising:
providing two male terminals;
inserting a male dielectric over the two male terminals;
inserting an open male outer contact over the male dielectric;
closing the male outer contact by applying a rear portion of the male outer contact behind the male dielectric;
inserting a male over-housing over the male outer contact; and
placing a male hold-down on the male over-housing and the male outer contact.
